(19) United States
(12) Patent Application Publication
(10) Pub. No.: US 2003/0195929 A1
(43) Pub. Date: Oct. 16, 2003

(54) Methods and system using secondary storage to store media data accessible for local area users

(76) Inventors: Michael Martin Franke, San Francisco, CA (US); Johnathan Bailey Gamble, San Francisco, CA (US); William Russell Henshall, San Francisco, CA (US); Aaron Sasha Cabral Jacobs, Oakland, CA (US); Matthew Donaldson Moller, San Francisco, CA (US)

Correspondence Address: Finnegan, Henderson, Farabow,, Garrett & Dunner, L.L.P., 1300 I Street, N.W., Washington, DC, 20005-3315, US

(21) Appl. No.: 10/123,332

(22) Filed: Apr. 15, 2002

(51) Int. Cl. G06F 15/16

(52) U.S. Cl. 709/204

(57) ABSTRACT

Methods and system are disclosed allowing media data to be stored on a secondary storage system accessible for local area users. Such users can thus post or store media data (“posted media data”) on a central server and on the secondary storage system. By such a process, posted media data on the central server is in effect “mirrored” on the secondary storage system. As a result, collaborating local area users can utilize the benefits (e.g., higher bandwidth and faster download speed) of accessing posted media data from a local area source (i.e., the secondary storage system). Furthermore, in order to avoid downloading incomplete posted media data, a completion signal or pending signal can be used to indicate if the posted media data has been completely stored or is in the process of being stored on the secondary storage system.

### RELATED APPLICATION

This application is related to U.S. patent application Ser. No. ______ entitled, “METHODS AND SYSTEM USING A LOCAL PROXY SERVER TO PROCESS MEDIA DATA FOR LOCAL AREA USERS,” filed on ______. The disclosure of this application is hereby expressly incorporated by reference.

### FIELD

This invention relates generally to data sharing systems and, more particularly, to methods and system using secondary storage to store media data accessible for local are users.

### BACKGROUND

Data sharing capabilities have increased tremendously with the popularity of wide area networks (WANs) such as the Internet. For example, disparate users in different countries or continents can share large amounts of shared data. Shared data may include multimedia data, audio data, and/or video data, typically in the form of large data files. Data sharing applications are commonly used to store or “post” shared data on a central server connected to the Internet for access by other users. Thus, a user can access the posted data via the central server.

One type of data sharing application is a “collaboration application.” A collaboration application allows multiple users to work together on the same project from remote locations. For example, users in California and New York can work on the same project via the Internet through a collaboration application. Typically, in a collaboration application, a user stores or “posts” data for the project on the central server connected to the Internet. Other users connected to the Internet can then request the posted data from the central server. The central server processes these requests to provide the users with posted data for collaboration purposes.

This configuration is suitable for users in remote locations. However, one limitation with such a configuration is that it is inefficient for multiple users collaborating on a project from the same local area, e.g., users on a LAN. Often, communicating with a central server can be slow. For example, if the central server is experiencing a high volume of traffic, the central server will be slow in delivering requested data to LAN users. Low bandwidth connections to the central server can exacerbate the situation. Thus, requiring local area users to download data from only a central server inefficiently uses network resources when the data may already exist locally. Furthermore, multiple local area users collaborating on a project using such a configuration can result in data being downloaded multiple times, causing further inefficient use of local area resources.

There exists, therefore, a need to allow local area users a fast and efficient manner of accessing posted data.

### SUMMARY

Methods and system consistent with the invention, as embodied and broadly described herein, allow local area users to access data from a secondary storage.

Consistent with the invention, one method is disclosed for implementing collaboration between a plurality of users operating a media application for processing media data. The users are interconnected via a first network and connected to a second network. The second network includes a central server and the first network includes a selectively enabled secondary storage system. The method includes storing media data on the central server. A determination is made if the secondary storage system is enabled. If the secondary storage system is enabled, the media data is also stored on the secondary storage system.

Consistent with the invention, another method is disclosed for implementing collaboration between a plurality of users operating a media application for processing media data. Each user has access to a central server and to at least one selectively enabled secondary storage system. Each secondary storage system is accessible to only a subset of the users. The method includes storing media data on the central server. A determination is made if the secondary storage system is enabled. If the secondary storage system is enabled, the media data is also stored on the on the secondary storage system.

Consistent with the invention, another method is disclosed for implementing collaboration between a plurality of users operating a media application for processing media data. Each user has access to a central server and to at least one selectively enabled secondary storage system. The method includes determining if the secondary storage system is enabled. If the secondary storage system is enabled, media data is stored on at least one of the central server and at least one of the secondary storage systems. The media data includes an identifier and the media data is stored with the identifier on the central server.

Consistent with the invention, another method is disclosed for implementing collaboration between a plurality of interconnected users on a network operating a media application for processing media data. Each user has access to a central server. The method includes connecting a secondary storage system to the network. The secondary storage system is selectively enabled. At least one user is configured to recognize the enabled secondary storage system and to post the media data for the media application on at least one of the central server and the enabled secondary storage system.

### DESCRIPTION OF THE DRAWINGS

The accompanying drawings, which are incorporated in, and constitute a part of the specification, illustrate implementations of the invention and, together with the detailed description, serve to explain the principles of the invention. In the drawings,

FIG. 1 is a block diagram of an exemplary system configuration for practicing the invention;

FIG. 2 is an internal block diagram of an exemplary computer system for implementing the invention;

FIG. 3 is a diagram of a project;

FIG. 4 is a diagram of a media application;

FIG. 5 is a diagram illustrating media and object flow for LAN users collaborating on a project;

FIG. 6 is a flow diagram of stages of a first method for storing media data on a secondary storage system;

FIG. 7 is a flow diagram of stages of a second method for storing media data on a secondary storage system;

FIGS. 8A and 8B are flow diagrams of stages of a first method for downloading and posting media data;

FIGS. 9A and 9B are flow diagrams of stages of a second method for downloading and posting media data;

FIG. 10 is a diagram of an exemplary interface illustrating a secondary storage system setting dialog;

FIG. 11 is a diagram of an exemplary interface illustrating a name dialog;

FIG. 12 is a diagram of an exemplary interface illustrating a select configuration dialog; and

FIG. 13 is a diagram of an exemplary interface illustrating a secondary storage system error dialog.

### DETAILED DESCRIPTION

Reference will now be made in detail to implementations of the invention, examples of which are illustrated in the accompanying drawings. Wherever possible, the same reference numbers will be used throughout the drawings to refer to the same or like parts.

The following implementations allow data, e.g., media data, to be stored on a secondary storage system accessible for local area users. These users can post media data (“posted media data”) on a central server and on the secondary storage system. By such a process, posted media data on the central server is in effect “mirrored” on the secondary storage system. As a result, collaborating local area users can utilize the benefits (e.g., higher bandwidth and faster download speed) of accessing posted media data from a local area source (i.e., the secondary storage system). Furthermore, in order to avoid downloading incomplete posted media data, a completion signal and pending signal can be used to indicate if the posted media data has been completely stored or is being stored on the secondary storage system for downloading purposes.

### Exemplary System Configuration

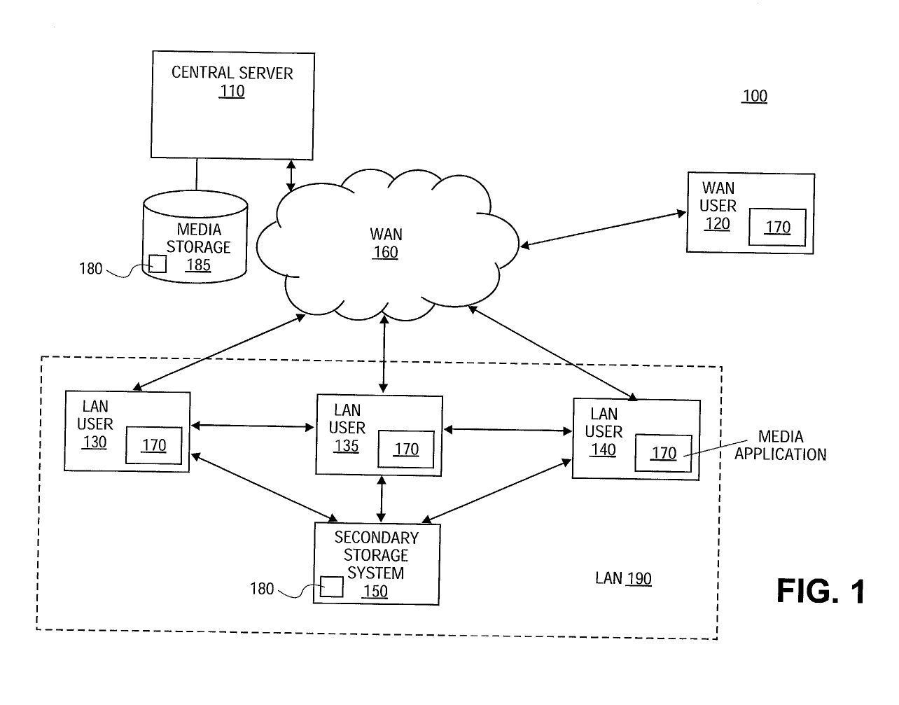

FIG. 1 is block diagram of an exemplary system configuration 100 for practicing the invention. System configuration 100 includes a plurality of users 130, 135, and 140 configured in a first network 190 such as, for example, a local area network LAN (“LAN 190”). Users 130, 135, and 140 (“LAN users 130-140”) are coupled to a central server 110 and user 120 via a second network 160 such as, for example, a wide area network WAN (“WAN 160”). Within LAN 190, LAN users 130-140 are coupled to a secondary storage system 150.

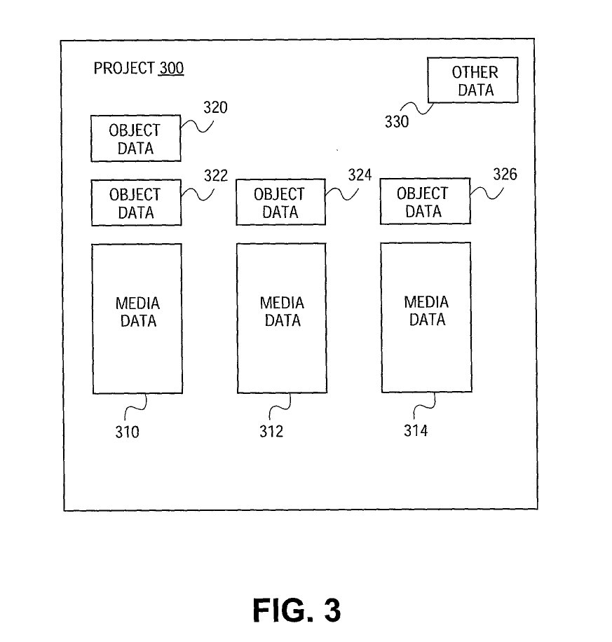

LAN users 130-140 and user 120 (“WAN user 120”) can share data via WAN 160 and LAN 190. For example, LAN users 130-140 and WAN user 120 can share data by collaborating on a project including project data. Project data may comprise media data and object data. Media data is a component of a project and object data is “meta data” associated with an element or component of the media data. Object data may include identification of a change to the media data. Examples of media data include digital audio and/or video data, MIDI data, text data, or large data files. Further details of project media data and object data are described in FIG. 3.

To collaborate on a project, LAN users 130-140 and WAN user 120 post or store media data on central server 110 for access by other users. For example, LAN users 130-140 and WAN user 120 can post or store media data on central server 110 using techniques described in U.S. application Ser. No. 09/401,318 (“the '318 application”) entitled “SYSTEM AND METHOD FOR ENABLING MULTIMEDIA PRODUCTION COLLABORATION OVER A NETWORK,” which was filed on Sep. 23, 1999, and is assigned to the same assignee of this application.

To make a change to the media data, LAN users 130-140 and WAN user 120 can send object data embodying the change to central server 110. Central server 110 can send the object data to LAN users 130-140 collaborating on the same project. For example, LAN users 130-140 and WAN user 120 can send object using the same techniques regarding media data as described in the '318 application and central server 110 can also send media data and/or object data to LAN users 130-140 and WAN user 120 using techniques described in the '318 application. As described in further detail below, LAN users 130-140 can store media data on secondary storage system 150 such that the media data is accessible on LAN 190. LAN users 130-140 can also store object data on secondary storage system 150 for access on LAN 190.

Secondary storage system 150 is a shared storage system for LAN users 130-140. Secondary storage system 150 provides shared data access and read/write capabilities for LAN users 130-140. Secondary storage system 150 can store media data and object data for LAN users 130-140. Secondary storage system 150 can be selectively enabled for each individual user of LAN users 130-140 to permit storing and downloading of media data 180 or object data (not shown) from secondary storage system 150 using the methods below. Examples of secondary storage system 150 include database storage systems having a server and one or more storage devices, a stand-alone storage device providing shared data access for LAN users 130-140, or other appropriate shared storage systems.

Alternatively, storage devices contained within or connected to one or more LAN users 130-140 may operate as secondary storage system 150. Secondary storage system 150 can provide standard network file sharing capabilities for LAN users 130-140. Although one secondary storage system 150 is shown, any number of shared or secondary storage systems or devices may be configured within LAN 190 and selectively enabled for use by LAN users 30-140, as described herein.

Secondary storage system 150 may also be accessible to central server 110 and WAN user 120. For example, central server 110 or WAN user 120 may store and download data to and from secondary storage system 150. Secondary storage system 150 may operate with applications to identify, organize, and reference posted media data 180 for LAN users 130-140 users or other users (e.g., WAN user 120). Secondary storage system 150 may store media data 180 in a compressed or uncompressed format and provide password protection for media data 180. In one example, LAN users 130-140 must logon to secondary storage system 150 to access media data 180.

LAN users 130-140 are computing devices that can communicate with each other and with central server 110, WAN user 120, and secondary storage system 150. Examples of LAN users 130-140 include computing systems such as Apple® Power Macintoshes or Intel® Pentium-based personal computers running a version of the Windows® operating system. Central server 110 and WAN user 120 may also comprise the same type of computing system as LAN users 130-140.

LAN users 130-140 and WAN user 120 can operate with a media application 170. Media application 170 can operate with one or more functions, procedures, routines, or application program interfaces (APIs) that allow media application 170 to collaborate, e.g., on a project, with other users and applications. For example, the collaboration system of Rocket Network, Inc. can be implemented as an application program interface (API) to media application 170 in order to provide the ability for LAN users 130-140 and WAN user 120 users to share data over network 160.

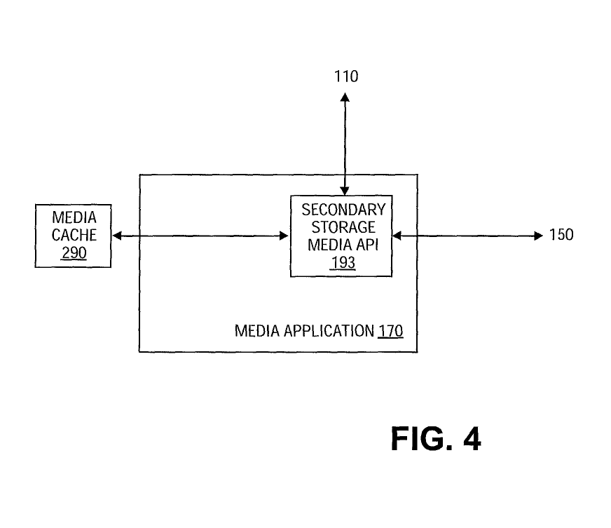

Examples of media application 170 include Logic Audio from Emagic Inc. of Grass Valley, California; Cubase from Steinberg Soft-und Hardware GmbH of Hamburg, Germany; or ProTools from Digidesign, Inc. of Palo Alto, Calif. Media application 170 may also be implemented as a client/server type application capable of sharing data with other users. Further details of the operation of media application 170 are described in FIG. 4.

Media application 170 can operate with one or more functions, procedures, routines, or application program interfaces (APIs) that allow media application 170 to collaborate, e.g., on a project, with other users and applications. For example, the collaboration system of Rocket Network, Inc. of San Francisco, Calif. can be implemented as an application program interface (API) to media application 170 in order for LAN users 130-140 and WAN user 120 users to collaborate on a project over WAN 160. This collaboration system can be based on the system described in the '318 application noted above.

Central server 110 is a computing system, which may include the same type of computing system as LAN users 130-140 and WAN user 120. Central server 110 includes client/server software and/or hardware for implementing collaboration between LAN users 130-140 and WAN user 120. For example, central server 110 can store and manage media data and object data in a project database to facilitate collaboration between LAN users 130-140 and WAN user 120 on the same project using techniques described in the '318 application noted above.

Attached to central server 110 is a media storage 185 storing media data 180. Media storage 185 can store other types of data including object data. Examples of media storage 185 include a hard disk, compact disc read/write (CD R/W) drives, tape drives, random access memory (RAM), or other like memory devices. Although one media storage 185 is shown, any number of storage devices may be attached to central server 110. Media storage 185 may include one or more project databases to store project data having media data and/or object for a plurality of projects.

Central server 110 can store media data from LAN users 130-140 or WAN user 120 as media data 180 in media storage 185. Central server 110 may also store object data (not shown) from these users in media storage 185 or in other storage devices. To facilitate network collaboration, central server 110 notifies LAN users 130-140 and WAN user 120 (if all are collaborating on the same project) of posted or stored media data and object data related to the project. For example, central server 110 can notify LAN users 130-140 and WAN user 120 using techniques described in the '318 application.

These users can thus request the media data or object data from central server 110 after being notified. Thus, central server 110 can provide media data and object data “on demand” or upon request by a user. Although central server 110 is shown connected to WAN 160 outside of LAN 190, central server 110 can be located within LAN 190 to facilitate collaboration from within LAN 190.

LAN 190 users and secondary storage system 150 may be configured in an Ethernet, Token Ring, ARCNET, fiber distributed data interface (FDDI) local area network, or other appropriate local area networks for LAN 190. WAN 160 may represent a wide area network such as, for example, the Internet or a proprietary wide area network. Although not shown, additional network devices may be connected to WAN 160 such as, for example, network routers, switches, hubs, or gateways. System configuration 100 is thus suitable for communicating data on LAN 190 and WAN 160 using standard local and wide area communication protocols. Thus, in the example of FIG. 1, because media data 180 is mirrored on secondary storage system 150, LAN users 130-140 are thus capable of accessing media data 180 within LAN 190. As such, the fast and high bandwidth qualities of a LAN are utilized for LAN users 130-140.

### Exemplary Computer System

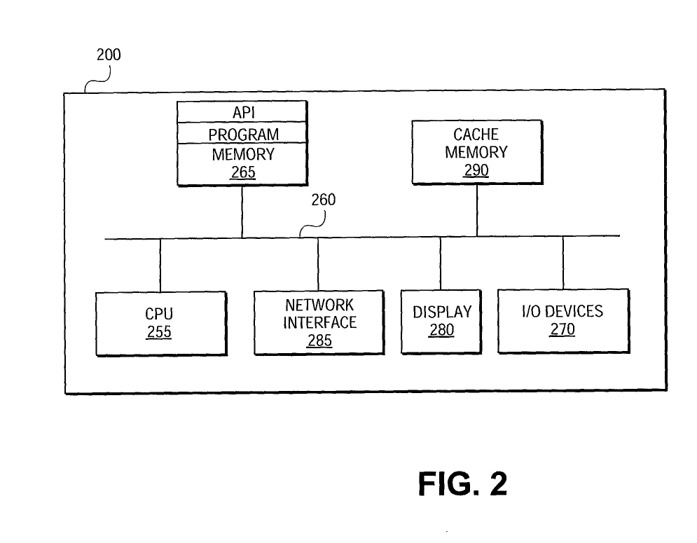

FIG. 2 is an internal block diagram of an exemplary computer system 200 for implementing the invention. Computer system 200 may represent the internal components of LAN users 130-140, WAN user 120, or central server 110 as shown in FIG. 1. Computer system 200 can perform the functions required by media application 170, as described in the methods below.

Computer system 200 includes several components all interconnected via a system bus 260. An example of system bus 260 is a bi-directional system bus having thirty-two data and address lines for accessing a memory 265 and a cache memory 290 and for transferring data among the components. Alternatively, multiplexed data/address lines may be used instead of separate data and address lines. Examples of memory 265 and cache memory 290 include a random access memory (RAM), read-only memory (ROM), video memory, flash memory, or other appropriate memory devices. Additional memory devices may be included in computer system 200 such as, for example, fixed and removable media (including magnetic, optical, or magnetic optical storage media). These types of media may also operate as cache memory.

Computing system 200 may communicate with other computing systems (e.g., central server 110 or WAN user 120) via a network interface 285. Examples of network interface 285 include Ethernet or dial-up telephone connections. Computer system 200 contains a central processing unit (CPU) 255, examples of which include the Pentium® family of microprocessors manufactured by Intel® Corporation. However, any other suitable microprocessor, micro-, mini-, or mainframe type processor may be used for computer system 200. CPU 255 provides the support for storing and downloading media data and is configured to carry out the methods described below.

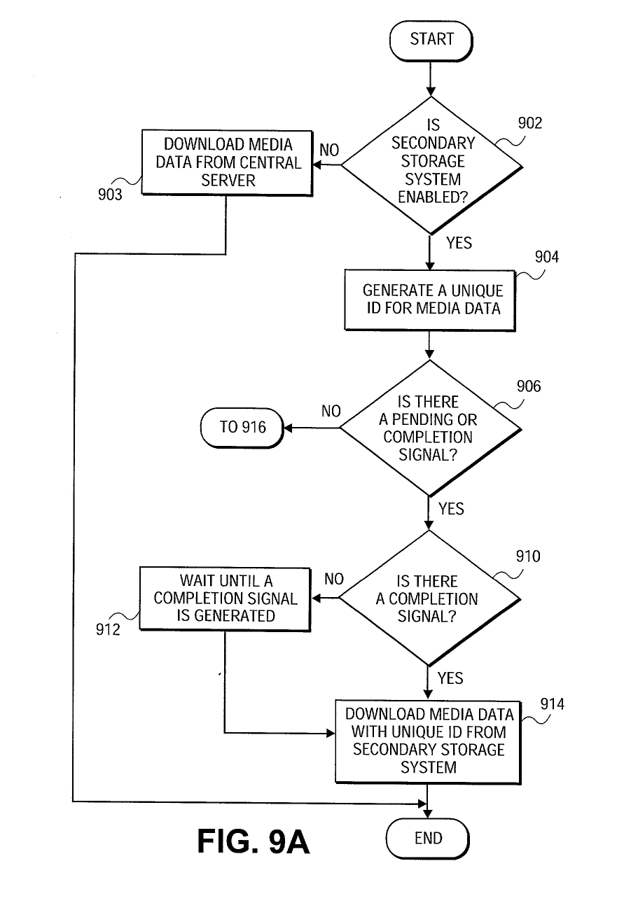

Memory 265 may store instructions or code for implementing a program (e.g., media application 170) and an application programming interface (API) (e.g., secondary storage media API 193 as shown in FIG. 4). For example, CPU 255 may execute media application 170 and secondary storage media API 193 to perform the methods described herein. Cache memory 290 may store media data (or data files) for storing or downloading to and from central server 110 and/or secondary storage system 150. Cache memory 290 may store other types of data, e.g., object data as shown in FIG. 3, to allow LAN users 130-140 to collaborate on a project. Computer system 200 may also receive input via input/output (I/O) devices 270. Examples of I/O devices 270 include a keyboard, pointing device, or other appropriate input devices. I/O devices 270 may also represent external storage devices or computing systems or subsystems. Computer system 200 may also present information (e.g., media data or user interfaces as described in FIGS. 10-13) via a display 280.

### Project

FIG. 3 is a diagram of a project 300. Project 300 may be stored on central server 110, e.g., in media storage 185. LAN users 130-140 and WAN user 120 may collaborate on project 300. That is, LAN users 130-140 may work together to create a data file representing, for example, a musical or multimedia arrangement. Such collaboration may be conducted in concurrent sessions or individually by each user at different instances in time.

Referring to FIG. 3, project 300 includes sets 320, 322, 324, and 326 of object data tied to sets 310, 312 and 314 of media data. In particular, sets 320 and 322 of object data are associated with set 310 of media data; set 324 of object data is associated set 312 of media data; and set 326 of object data is associated with set 314 of media data. Project 300 may also include a set 330 of other data, e.g., this may contain a list of all users collaborating on project 300.

Sets 310, 312, and 314 of media data are components of project 300 in which user modifications or changes can be made. Sets 320, 322, 224, and 326 of object data are “meta data” associated with sets 310, 312, and 314 of media data. Object data may represent a change or modification of an element of media data. For example, a change or modification to set 310 of media data can be embodied in sets 320 and 322 of object data.

Referring back to FIG. 1, to collaborate on project 300 between LAN users 130-140, LAN user 130 can post set 310 of media data and sets 320 and 322 of object data on central server 110. LAN user 130 can also post set 310 of media data on secondary storage system 150 such that set 310 of media data is accessible for LAN users 135 and 140. Central server 110 notifies LAN users 135 and 140 of the posted set 310 of media data and sets 320 and 322 of object data. LAN users 130 and 140 can thus download set 310 of posted media data from secondary storage system 150. Alternatively, sets 320 and 322 of object data can also be posted and downloaded to and from secondary storage system 150.

### Media Application

FIG. 4 shows media application 170 in greater detail. For LAN users 130-140 or WAN user 120, media application 170 includes a secondary storage media application program interface (API) 193 (“API 193”). API 193 is a software component tied into media application 170. API 193 includes one or more functions, procedures, routines, or sub-routines that implement processes to interface media application 170 to a media cache 290, central server 110, and secondary storage system 150. Alternatively, the processes performed by API 193 can be implemented by media application 170 alone. Media cache 290 can store project 300 data for media application 170.

API 193 can be configured or programmed to implement the methods described below. For example, the collaboration system of Rocket Network, Inc. can be implemented as API 193 and be configured or programmed to selectively enable secondary storage system 150 for use by LAN users 130-140 using the techniques described in FIGS. 10-13. In one implementation, secondary storage system 150 can be selectively enabled for use by LAN users by configuring or programming API 193 to recognize and to post/download media data to and from secondary storage system 150.

To post media data, API 193 can send media data stored in media cache 290 to central server 110 or secondary storage system 150. To download posted media data, API 193 can copy posted media from central server 110 or secondary storage system 150 and store the data in media cache 290. To communicate with central server 110 or secondary storage system 190, API 193 may use a File Transfer Protocol (FTP) or other standard file sharing protocols to transfer and access media data to and from central server 110 or secondary storage system 150. API 193 can be seamlessly integrated into media application 170 such that media application 170 is unaware that media data is being stored or downloaded from secondary storage system 150.

API 193 may perform other types of functions. For example, API 193 may determine whether posted media data 180 is stored on secondary storage system 150 and access it from secondary storage system 150 if requested by media application 170. If API 193 determines that posted media data 180 is not stored on secondary storage system 150, API 193 may download posted media data 180 from central server 110. API 193 can also determine if media data (or data files) cached or stored in media cache 290 is stored on secondary storage system 150. Additionally, API 193 may provide interfaces (e.g., as shown in FIGS. 10-13) for a user to configure preferences for secondary storage system 150, to display media data, to provide a status of the storing or downloading process.

### Object and Media Flow

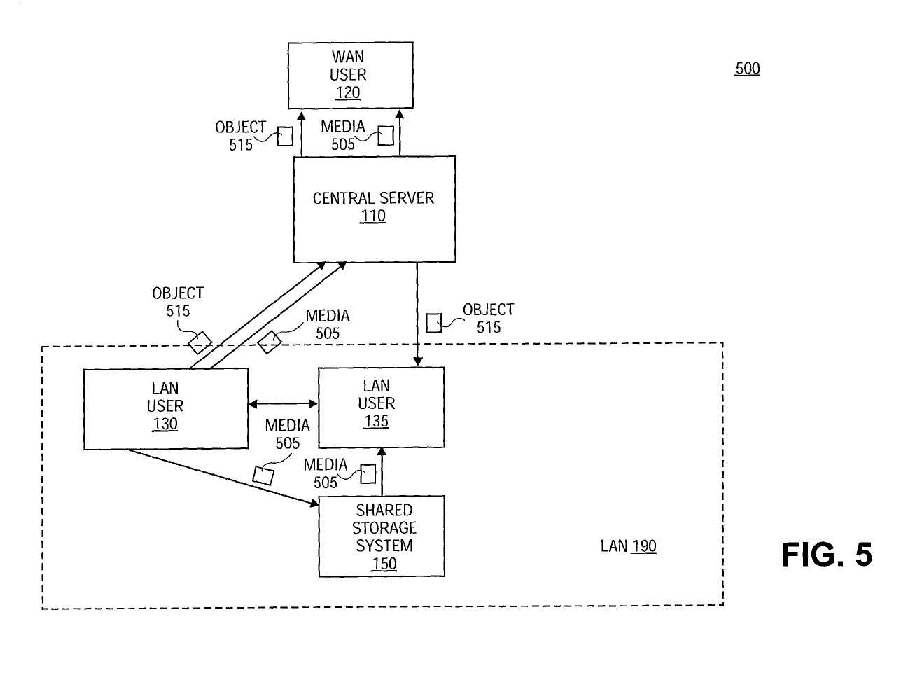

FIG. 5 is a diagram of media and object flow for LAN users 130140 collaborating on a project. LAN users 130 and 135 and WAN user 120 are shown collaborating on a project (e.g., project 300). For purposes of illustration, initially, LAN users 130 and 135 and WAN user 120 do not contain the same object data (“object 515”) or media data (“media 505”).

Referring to FIG. 5, LAN user 130 makes a change to media 505 with object 515. In order to ensure access to data on the shortest and fastest possible network route, LAN user 130 stores media 505 on central server 110 and on secondary storage system (“shared storage system” 150. LAN user 130 also stores object 515 on central server 110. Central server 110 notifies LAN user 135 and WAN user 120 collaborating on the same project of the change. LAN user 135 or other users (e.g., WAN user 120) can download object 515 or media 505 from central server 110 “on demand.” That is, central server 110 does not force object or media data onto a user. Users can thus request object 515 and media 505 from central server 110. In a preferred implementation, LAN user 135 downloads media 505 from shared storage system 150 instead of from central server 110. Thus, LAN user 135 efficiently utilizes local area resources.

### Mirroring Media Data on Secondary Storage System

The following flow diagrams detail methods for storing or mirroring media data on secondary storage system 150. The following methods can be implemented for storing or mirroring other types of data on secondary storage system 150 including object data, text data, image data, graphical data, binary data, compressed data, rendered data, or any combination of the above data.

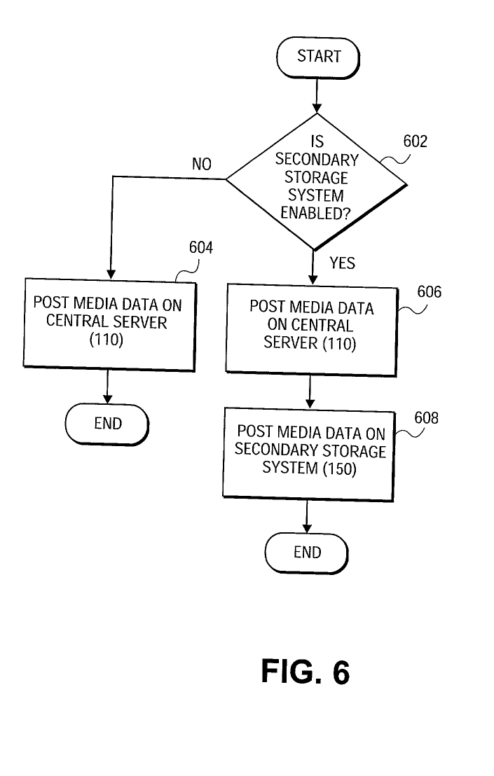

FIG. 6 is a flow diagram of stages in a first method for storing media data on secondary storage system 150. This method can be implemented for one or more data files containing media data.

After the process begins, a check is made to determine if secondary storage system 150 is enabled (stage 602). A user can enable secondary storage system 150 or other secondary storage devices connected in LAN 190 by using interfaces such as those shown in FIGS. 10-13. If secondary storage system 150 is enabled, media data is posted on central server 110 and on secondary storage system 150 (stages 606 and 608). For example, posted media data 180 stored on central server 110 is also stored on secondary storage system 150. The order of stages 606 and 608 can be reversed or performed simultaneously. This in effect mirrors media data 180 on secondary storage system 150 and allows LAN users 130-140 access to media data 180 via LAN 190. If secondary storage system 150 is not enabled, media data is stored only on central server 110 (stage 604).

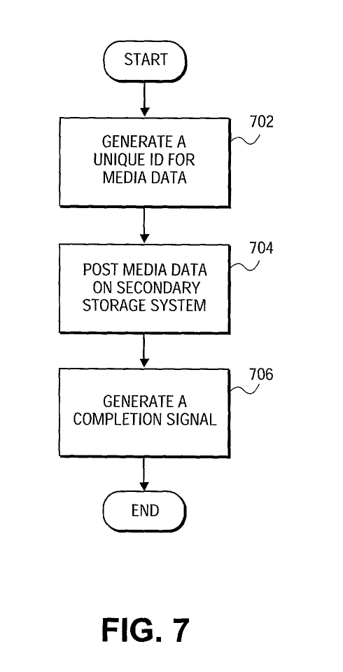

FIG. 7 is a flow diagram of stages of a second method for storing media data on secondary storage system 150. This method can be implemented for one or more data files containing media data.

After the process begins, a unique identifier (ID) or file name is generated for media data (stage 702). Examples of a unique identifier may include a globally unique ID (GUID) identifying a version or attribute of the media data. By using a GUID, media data on secondary storage system 150 can be differentiated. Alternatively, a unique ID can be generated for groups of media data, e.g., by a common project. That is, folders can be created to store common media data, each of which contains the same unique folder name.

In one implementation, if a standard filing system (such as UNIX) is used to organize and store the media data, attributes such as: “File Creator”, “User Name”, “File Creation Time”, and “Original File Name” can be used. With these attributes, a unique file name or ID can be generated by concatenating the Creator User Account Name, the File Creation Time and the Original File Name. (e.g. Matt1-123456789456123-datafile1.doc). This ensures that the name of each media data will be unique. By using such an ID generating process, an exemplary folder hierarchy is shown below.

Parent Directory (root directory on the secondary storage System)

Project1 (folder)

Aaron1—123456789123-datafile1.doc (file)

Mike1—894576890532-datafile1.doc (file)

Project2 (folder)

Aaron1—72384732874-picture.jpg (file)

Mike1—77773234234-mynotes.txt (file)

Project3 (folder) . . .

As shown in the above example, each folder name (e.g., Project1 to Project3) is unique and each media data name within the folder is also unique. After a unique ID is generated for the media data, the media data is posted on secondary storage system 150 with its unique ID (stage 704). While the media data is being posted or stored, an indication can be provided to LAN users 130-140 that the media data has not yet been completely posted. After the media data is completely posted on secondary storage system 150, a completion signal is generated (stage 706). This completion signal notifies other LAN users 130-140 that the media data has been completely posted on secondary storage system 150 and is ready for downloading.

By using the completion signal, a user can avoid downloading an incomplete copy of media data. The completion signal can be indicated using a number of techniques. For example a special identifier, e.g., “.cmplt” can be appended to the unique ID for the media data. An indication can be made in a database record to show that the media data has been completely stored. Additionally, a check can be made on the media data size in secondary storage system 150 with the required file size for the media data. Other examples of providing the completion signal include secondary storage system 150 broadcasting a signal or data that the media data has been successfully posted. The completion signal may also be based on media data attributes.

### Downloading and Storing Downloaded Media Data

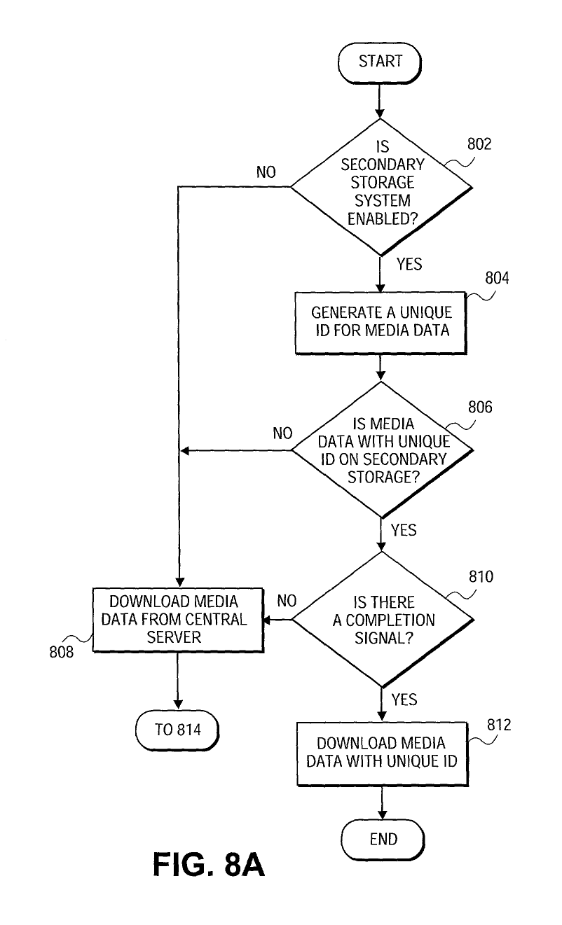

The following flow diagrams detail methods for downloading and storing or posting downloaded media data. The following methods describe using a completion or pending signal to ensure that completely stored media data is accessed. The following methods can be implemented for downloading and storing or posting other types of data including object data, text data, image data, graphical data, binary data, compressed data, rendered data, or any combination of the above data. FIGS. 8A and 8B are flow diagrams of stages of a first method for downloading and storing of media data. This method can be implemented with one or more data files containing media data.

Referring to FIG. 8A, initially, a LAN user is in the process of requesting media data to be downloaded. A check is made to determine if secondary storage system 150 is enabled (stage 802). If secondary storage system 150 is not enabled, the requested media data is downloaded from central server 110 (stage 808). From stage 808, the method continues to stage 814 in FIG. 8B. If secondary storage system 150 is enabled, a unique ID for the requested media data is generated as described in FIG. 7 (stage 804). This stage is optional if the unique ID has been previously generated. The unique ID can be generated for the media data before implementing this method.

A check is then made to determine if the media data having the unique ID is stored on secondary storage system 150 (stage 806). If no media data having the unique ID is stored on secondary storage system 150, the media data is downloaded from central server 110 (stage 808). If the media data having the unique ID is stored on secondary storage system 150, a check is made to determine if there is a completion signal for the media data (stage 810). If there is no completion signal, the media data is downloaded from central server 110 (stage 808). If there is a completion signal indicating that the requested media is completely stored on secondary storage system 150, the media data is downloaded from secondary storage system 150. The downloaded media data can be stored or cached by the LAN users 130-140.

Referring to FIG. 8B, if stage 808 is performed in FIG. 8A and requested media data is downloaded from central server 110, the following stages can be implemented to store or post the downloaded media data on secondary storage system 150 such that is accessible on LAN 190. Continuing from stage 808 a check is made to determine if a secondary storage system 150 is enabled (stage 814). If secondary storage system 150 is not enabled, the process ends and the downloaded media data is not mirrored on a secondary storage system 150.

If secondary storage system 150 is enabled, a unique ID for the downloaded media data is generated as described in FIG. 7 (stage 816). A check is then made to determine if the media data having the unique ID is stored on secondary storage system 150 (stage 818). If no media data having the unique ID is stored on secondary storage system 150, the media data is stored or posted on secondary storage system 150 (stage 820). A completion signal is then generated after the media data has been stored on secondary storage system 150 (822).

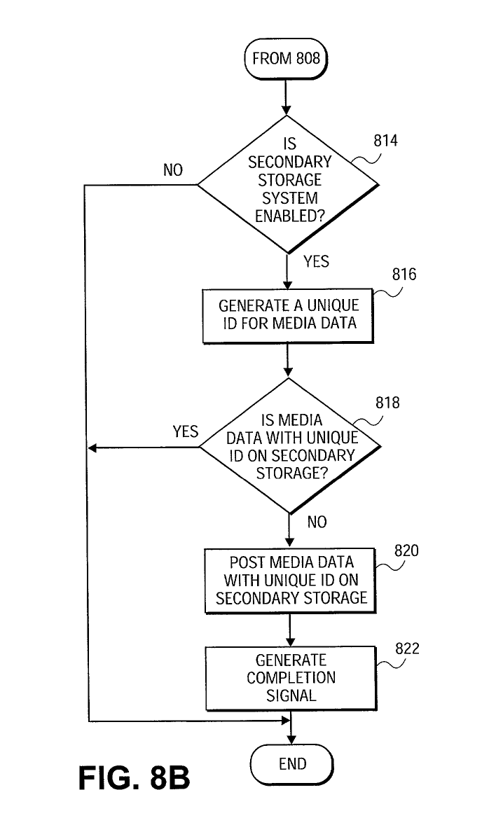

FIGS. 9A and 9B are flow diagrams of stages of a second method for downloading and storing of media data. This method can be implemented with one or more data files containing media data.

Referring to FIG. 9A, initially, a LAN user is in the process of requesting media data to be downloaded. A check is made to determine if secondary storage system 150 is enabled (stage 902). If secondary storage system 150 is not enabled, the requested media data is downloaded from central server 110 (stage 903) and the process ends. If secondary storage system 150 is enabled, a unique ID is generated for the requested media data as described in FIG. 7 (stage 904). This stage is optional if the unique ID has been previously generated. The unique ID can be generated for the media data before implementing this method.

A check is then made to determine if there is a “pending signal” or “completion signal” being asserted (stage 906). A pending signal can be used in conjunction with the completion signal described above to indicate that media data having the same unique ID is in the process of being stored or posted on secondary storage system 150. The pending signal can be generated in the same manner as the completion signal described above, but indicating a pending status. If there is no pending signal or completion signal, the process continues to stage 916 in FIG. 9B.

If there is a pending signal or completion signal, a check is made to determine if the signal is a completion signal to indicate that the media is stored or posted on secondary storage system 150 (stage 910). If there is a completion signal, the requested media data with the unique ID is downloaded from secondary storage system 150 (stage 914). If there is no completion signal, the process waits until a completion signal is generated (stage 912). In an alternative implementation, stage 912 can be modified to allow for a streaming process of downloading segments of media data as soon as the segments become available on secondary storage system 150. Once a completion signal is generated, the process continues to stage 914 such that the media data with the unique ID is downloaded from secondary storage system 150.

Referring to FIG. 9B, if there is no pending signal or completion signal at stage 906 in FIG. 9A, the following stages can be performed to generate and clear a pending signal. Continuing from stage 906 a pending signal is generated (stage 916). For example, a pending signal can be generated in the same manner as generating a competition signal in that the pending indicates that media data is in the process of being stored or posted. After the pending signal is generated, the requested media data with the unit ID is downloaded from central server 110 (stage 918). The downloaded media data from central server 110 is posted on secondary storage system 150 (stage 920).

After being stored on secondary storage system 150, a completion signal is generated (stage 922). Then, the pending signal is cleared. (stage 924).

Selectively Enabling Secondary Storage System

FIGS. 10-13 illustrate exemplary user interfaces 1010, 1110, 1210, and 1310, which may be provided by media application 170 or API 193 for LAN users 130-140, to selectively-enable secondary storage system 150 in performing the methods described above.

Referring to FIG. 10, user interface 1010 depicts a secondary storage system (or mirror settings) dialog interface for selectively enabling secondary system 150. User interface 1010 includes a plurality of input fields 1015 through 1050 allowing a user to configure settings for storing or downloading media data. Media application 170 can provide a menu option or an access button to initiate user interface 1010.

At interface 1010, a user can input “Server URL”, “Pathname”, “Username”, and “Password” information at inputs 1020, 1025, 1030, and 1035. A window 1040 can display sessions or projects assigned to the user. When storing or receiving media data for a session for the first time, user interface 1010 presents an options window 1050 allowing a user to choose one of the following: “Ask Me What to Do”, “Don't Mirror”, or “Assign To:”. If the “Ask Me What to Do” option is selected, a help window is displayed informing the user of options that can be selected for user interface 1010. If the “Don't Mirror” option is selected, secondary storage system 150 is not enabled and media data is posted directly on central server 110.

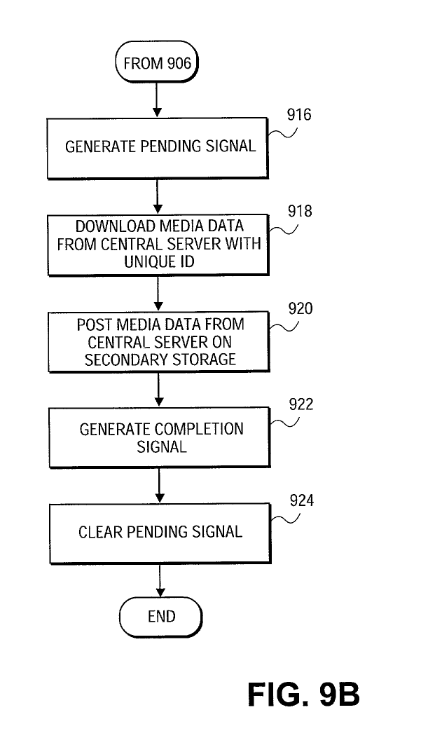

If “Assign To:” option is selected, a drop down menu is provided that allows a user to choose one of the following options: “Add Configuration”, “Remove Session”, “Rename Configuration”, “Delete Configuration”, or “Save Configuration”. If the “Add Configuration” option is selected, interface 1110, as shown in FIG. 11, is provided to the user. The user can then add a name at input field 1115 for the new configuration to be created. If the “Remove Session” option is selected, a list of session names is provided in which the user can select to have removed from interface 1010. If the “Rename Configuration”, “Delete Configuration”, or “Save Configuration” options are selected, an interface is provided to allow the user to perform the corresponding function. With the above options, a user can configure settings to store and download media data from secondary storage system 150.

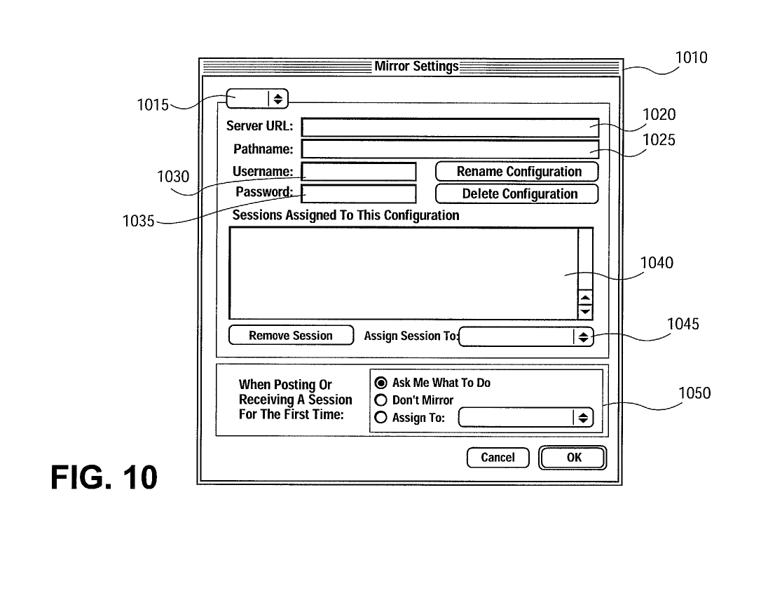

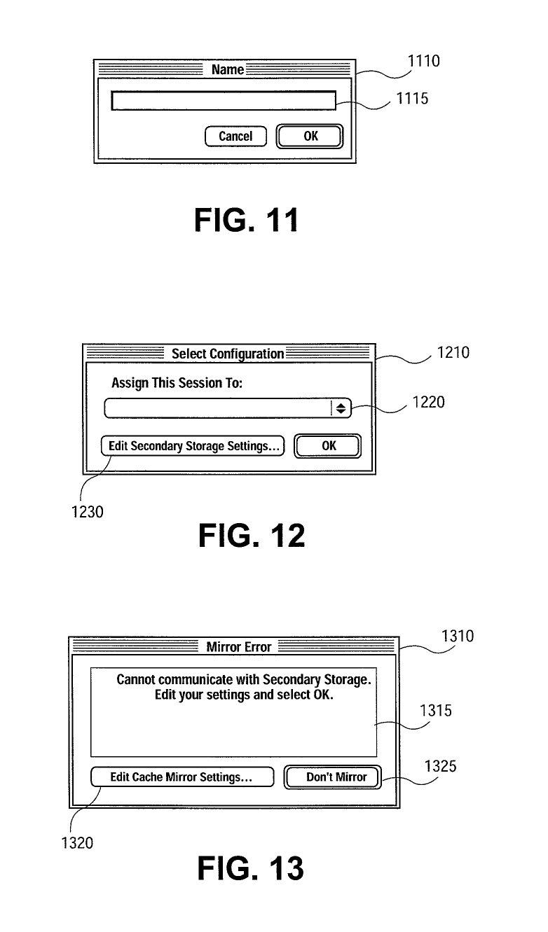

Referring to FIG. 12, user interface 1210 depicts a select “Configuration Dialog” for creating or loading a session. A user can assign or select a session using input 1220. An “Edit Secondary Storage Settings” option 1230 is provided for a user. If a user selects option 1230, the user can change or edit the secondary storage settings for the selected session as shown by interface 1010 of FIG. 10. Referring to FIG. 13, user interface 1310 is provided if there is an error in communicating with secondary storage system 150. For example, window 1315 can display a message such as “Cannot communicate with Secondary Storage. Edit your settings and select OK.” Thus, user interface 1310 provides a “Edit Cache Mirror Settings” option 1320 or “Don't Mirror” option 1325 for a user to select. The user can select option 1320 to change settings to correct the error or can select option 1325 to avoid communicating with secondary storage system 150.

The above implementations can have many variations without departing from the spirit and scope of the invention. For example, the above methods can be modified to store media data and object data on only secondary storage system 150. In this case, media data identifier information is passed to central server 110 that distributes the identifier information to the users, which can use this information to download the media data and object data. Additionally, for the above methods, different or varying versions of media data can be posted on secondary storage system 150, e.g., media data can be posted in a compressed format or with low or high quality resolution.

Furthermore, although aspects of the invention are described in which programs, application, modules, functions, routines, or sub-routines are stored in memory, such memory may include computer-readable media such as, for example, hard disks, floppy disks, CD-ROMs; a carrier wave from the Internet; or other forms of RAM or ROM. Similarly, the methods of the invention may conveniently be implemented in software and/or hardware modules that are based upon the flow diagrams of FIGS. 6, 7, 8A-8B, and 9A-9B and user interfaces shown in FIGS. 10 through 13.

No particular programming language has been indicated for carrying out the various methods described above because it is considered that the operations, stages and procedures described herein and illustrated in the accompanying drawings are sufficiently enabling to practice the invention. Moreover, any number of computers and operating systems may be used to practice the invention. Each user of a particular computer will be aware of the language and tools which are most useful for that user's needs and purposes to practice and implement the invention. Accordingly, the scope of the present invention is defined by the appended claims rather than the foregoing description.

What is claimed is:

1. A method for implementing collaboration between a plurality of users operating a media application for processing media data, including users interconnected via a first network and connected to a second network, the second network including a central server and the first network including a selectively enabled secondary storage system, the method comprising:
storing media data on the central server;
determining if the secondary storage system is enabled; and
storing the media data on the secondary storage system if the secondary storage system is enabled.

2. The method of claim 1 wherein the first network includes a local area network (LAN) and the second network includes a wide area network (WAN).

3. The method of claim 1 wherein storing the media data includes storing of at least one data file containing media data.

4. The method of claim 3 further comprising:
generating a unique identifier for each data file; and
storing each data file on the secondary storage system, and
accessing each stored data file using the identifier for the data file.

5. The method of claim 1 further comprising selectively enabling the secondary storage system by a user.

6. The method of claim 1 further comprising generating a notification of the storing of the media data and transmitting the notification to the users.

7. The method of claim 6 further comprising generating a completion signal when the media data is stored on the secondary storage system.

8. The method of claim 7 further comprising:
receiving the notification; and
downloading the media data from the secondary storage system if the secondary storage system has been enabled and the completion signal has been generated.

9. The method of claim 7 further comprising:
receiving the notification; and
if the secondary storage system has been enabled, downloading the media data from the secondary storage system only upon determination that the completion signal has been generated.

10. The method of claim 9 further comprising retrieving the media data from the central server if the secondary storage system is not enabled.

11. The method of claim 10 further comprising retrieving the media data from the central server if the completion signal is not received within a predetermined period of time.

12. The method of claim 11 wherein retrieving the media data from the central server comprises:
determining if the secondary storage system is enabled and the media data is on the secondary storage system; and
storing the media data on the secondary storage system if the secondary storage system is enabled and the media data is not on the secondary storage system.

13. The method of claim 12 further comprising generating a completion signal after the media data is stored on the secondary storage system.

14. The method of claim 1 further comprising generating a pending signal if the media data is in process of being stored on the secondary storage system.

15. The method of claim 14 further comprising:
determining if there is a completion signal; and
retrieving the media data from the secondary storage system if there is a completion signal.

16. The method of claim 15 wherein the retrieving of the media data includes waiting for the completion signal if there is no completion signal.

17. The method of claim 14 further comprising:
generating a pending signal if the media data is not in process of being stored on the secondary storage system;
retrieving the media data from the central server;
storing the retrieved media data on the secondary storage system if enabled;
generating a completion signal after the media data is stored on the secondary storage system; and
clearing the pending signal.

18. A method for implementing collaboration between a plurality of users operating a media application for processing media data, each user having access to a central server and to at least one selectively enabled secondary storage system, each secondary storage system being accessible to only a subset of the users comprising, the method comprising:
storing media data on the central server;
determining if the secondary storage system is enabled; and
storing the media data on the secondary storage system if the secondary storage system is enabled.

19. The method of claim 18 wherein storing the media data includes storing of at least one data file containing media data.

20. The method of claim 19 further comprising:
generating a unique identifier for each data file; and
storing each data file on the secondary storage system, and
accessing each stored data file using the identifier for the data file.

21. The method of claim 18 further comprising selectively enabling the secondary storage system by a user.

22. The method of claim 18 further comprising generating a notification of the storing of the media data and transmitting the notification to the users.

23. The method of claim 22 further comprising generating a completion signal when the media data is stored on the secondary storage system.

24. The method of claim 23 further comprising:
receiving the notification; and
downloading the media data from the secondary storage system if the secondary storage system has been enabled and the completion signal has been generated.

25. The method of claim 23 further comprising:
receiving the notification; and
if the secondary storage system has been enabled, downloading the media data from the secondary storage system only upon determination that the completion signal has been generated.

26. The method of claim 25 further comprising retrieving the media data from the central server if the secondary storage system is not enabled.

27. The method of claim 26 further comprising retrieving the media data from the central server if the completion signal is not received within a predetermined period of time.

28. The method of claim 27 wherein retrieving the media data from the central server comprises:
determining if the secondary storage system is enabled and the media data is on the secondary storage system; and
storing the media data on the secondary storage system if the secondary storage system is enabled and the media data is not on the secondary storage system.

29. The method of claim 28 further comprising generating a completion signal after the media data is stored on the secondary storage system.

30. The method of claim 18 further comprising generating a pending signal if the media data is in process of being stored on the secondary storage system.

31. The method of claim 30 further comprising:
determining if there is a completion signal; and
retrieving the media data from the secondary storage system if there is a completion signal.

32. The method of claim 31, wherein the retrieving of the media data includes waiting for the completion signal if there is no completion signal.

33. The method of claim 30 further comprising:
generating a pending signal if the media data is not in process of being stored on the secondary storage system;
retrieving the media data from the central server;
storing the retrieved media data on the secondary storage system if enabled;
generating a completion signal after the media data is stored on the secondary storage system; and
clearing the pending signal.

34. A method for implementing collaboration between a plurality of users operating a media application for processing media data, each of the users having access to a central server and to at least one selectively enabled secondary storage system, the method comprising:
determining if the secondary storage system is enabled;
if the secondary storage system is enabled, storing media data on at least one of the central server and at least one of the secondary storage systems if the secondary storage system is enabled, the media data including an identifier; and
storing the media data with the identifier on the central server.

35. A method for implementing collaboration between a plurality of users on a network operating a media application for processing media data, each of the users having access to a central server, the method comprising:
connecting a secondary storage system to the network;
selectively enabling the secondary storage system;
configuring at least one of the users to recognize the enabled secondary storage system and to post the media data for the media application on at least one of the central server and the enabled secondary storage system.

36. A system for implementing collaboration between a plurality of users operating a media application for processing media data, including users interconnected via a first network and connected to a second network, the second network including a central server and the first network including a selectively enabled secondary storage system, the system comprising:
a memory storing instructions for implementing the media application to process media data;
a processor configured to execute the instructions to perform:
storing media data on the central server;
checking if the secondary storage system is enabled; and
storing the media data on the secondary storage system if the secondary storage system is enabled.

37. The system of claim 36 wherein the first network includes a local area network (LAN) and the second network includes a wide area network (WAN).

38. The system of claim 36 wherein the processor is configured to execute the instructions to perform storing of at least one data file containing media data.

39. The system of claim 38 wherein the processor is configured to execute the instructions to perform:
generating a unique identifier for each data file; and
storing each data file on the secondary storage system, and
accessing each stored data file using the identifier for the data file.

40. The system of claim 36 wherein the processor is configured to execute the instructions to perform selectively enabling the secondary storage system by a user.

41. The system of claim 36 wherein the processor is configured to execute the instructions to perform generating a notification of the storing of the media data and transmitting the notification to the users.

42. The system of claim 41 wherein the processor is configured to execute the instructions to perform generating a completion signal when the media data is stored on the secondary storage system.

43. The system of claim 42 wherein the processor is configured to execute the instructions to perform:
receiving the notification; and
downloading the media data from the secondary storage system if the secondary storage system has been enabled and the completion signal has been generated.

44. The system of claim 42 wherein the processor is configured to execute the instructions to perform:
receiving the notification; and
if the secondary storage system has been enabled, downloading the media data from the secondary storage system only upon determination that the completion signal has been generated.

45. The system of claim 44 wherein the processor is configured to execute the instructions to perform retrieving the media data from the central server if the secondary storage system is not enabled.

46. The system of claim 45 wherein the processor is configured to execute the instructions to perform retrieving the media data from the central server if the completion signal is not received within a predetermined period of time.

47. The system of claim 46 wherein the processor is configured to execute the instructions to perform:
determining if the secondary storage system is enabled and the media data is on the secondary storage system; and
storing the media data on the secondary storage system if the secondary storage system is enabled and the media data is not on the secondary storage system.

48. The system of claim 47 wherein the processor is configured to execute the instructions to perform generating a completion signal after the media data is stored on the secondary storage system.

49. The system of claim 36 wherein the processor is configured to execute the instructions to perform generating a pending signal if the media data is in process of being stored on the secondary storage system.

50. The system of claim 48 wherein the processor is configured to execute the instructions to perform:
determining if there is a completion signal; and
retrieving the media data from the secondary storage system if there is a completion signal.

51. The system of claim 50 wherein the processor is configured to execute the instructions to perform waiting for the completion signal if there is no completion signal.

52. The method of claim 49 wherein the processor is configured to execute the instructions to perform:
generating a pending signal if the media data is not in process of being stored on the secondary storage system;
retrieving the media data from the central server;
storing the retrieved media data on the secondary storage system if enabled;
generating a completion signal after the media data is stored on the secondary storage system; and
clearing the pending signal.

53. A system for implementing collaboration between a plurality of users operating a media application for processing media data, each of the users having access to a central server and to at least one selectively enabled secondary storage system, each of the secondary storage systems being accessible to only a subset of the users, the system comprising:
a memory storing instructions for implementing the media application to process media data;
a processor configured to execute the program instructions to perform:
storing media data on the central server;
checking if the secondary storage system is enabled; and
storing the media data on the secondary storage system if the secondary storage system is enabled.

54. The system of claim 53 wherein the processor is configured to execute the instructions to perform storing of at least one data file containing media data on the central server and secondary storage system.

55. The system of claim 54 wherein the processor is configured to execute the instructions to perform:
generating a unique identifier for the data file;
storing the data file on the secondary storage system; and
accessing the data file using the identifier.

56. The system of claim 53 wherein the processor is configured to execute the instructions to perform selectively enabling the secondary storage system by a user.

57. The system of claim 53 wherein the processor is configured to execute the instructions to perform generating a notification of the storing of the media data on the central server and secondary storage system and transmitting the notification to the users.

58. The system of claim 57 wherein the processor is configured to execute the instructions to perform generating a completion signal when the media data is stored on the secondary storage system.

59. The system of claim 58 wherein the processor is configured to execute the instructions to perform:
receiving the notification; and
downloading the media data from the secondary storage system if the secondary storage system has been enabled and the completion signal has been generated.

60. The system of claim 58 wherein the processor is configured to execute the instructions to perform:
receiving the notification; and
if the secondary storage system has been enabled, downloading the media data from the secondary storage system only upon determination that the completion signal been generated.

61. The system of method of claim 60 wherein the processor is configured to execute the instructions to perform retrieving the media data from the central server if the secondary storage system is not enabled.

62. The system of claim 60 wherein the processor is configured to execute the instructions to perform retrieving the media data from the central server if the completion signal is not received within a predetermined period of time.

63. The system of claim 62 wherein the processor is configured to execute the instructions to perform:
determining if the secondary storage system is enabled and the media data is on the secondary storage system; and
storing the media data on the secondary storage system if the secondary storage system is enabled and the media data is not on the secondary storage system.

64. The system of claim 63 wherein the processor is configured to execute the instructions to perform generating a completion signal after the media data is stored on the secondary storage system.

65. The system of claim 53 wherein the processor is configured to execute the instructions to perform generating a pending signal if the media data is in process of being stored on the secondary storage system.

66. The system of claim 65 wherein the processor is configured to execute the instructions to perform:
determining if there is a completion signal; and
retrieving the media data from the secondary storage system if there is a completion signal.

67. The system of claim 64 wherein the processor is configured to execute the instructions to perform waiting for the completion signal if there is no completion signal.

68. The method of claim 65 wherein the processor is configured to execute the instructions to perform:
generating a pending signal if the media data is not in process of being stored on the secondary storage system;
retrieving the media data from the central server;
storing the retrieved media data on the secondary storage system if enabled;
generating a completion signal after the media data is stored on the secondary storage system; and
clearing the pending signal.

69. A computer-readable medium containing instructions, which if executed by a computing system, cause the computing system to perform a method for implementing collaboration between a plurality of users operating a media application for processing media data, including users interconnected via a first network and connected to a second network, the second network including a central server and the first network including a selectively enabled secondary storage system, the method comprising:
storing media data on the central server;
checking if the secondary storage system is enabled; and
storing the media data on the secondary storage system if the secondary storage system is enabled.

70. A computer-readable medium containing instructions, which if executed by a computing system, cause the computing system to perform a method for implementing collaboration between a plurality of users operating a media application for processing media data, each of the users having access to a central server and to at least one selectively enabled secondary storage system, each of the secondary storage systems being accessible to only a subset of the users, the method comprising:
storing media data on the central server;
checking if the secondary storage system is enabled; and
storing the media data on the secondary storage system if the secondary storage system is enabled.

71. A computer-readable medium containing instructions, which if executed by a computing system, cause the computing system to perform a method for implementing collaboration between a plurality of interconnected users operating a media application for processing media data, each of the users having access to a central server and to at least one selectively enabled secondary storage system, the method comprising:
checking if the secondary storage system is enabled;
if the secondary storage system is enabled, storing media data on at least one of the central server and the secondary storage system, the media data including identifier information; and
storing the identifier information on the central server.
